(19) United States
(12) Patent Application Publication
(10) Pub. No.: US 2026/0177299 A1
(43) Pub. Date: Jun. 25, 2026

(54) METHOD FOR OPERATING A COOLANT CIRCUIT, AND MOTOR VEHICLE

(71) Applicant: AUDI AG, Ingolstadt (DE)

(72) Inventors: Dirk SCHROEDER, Manching (DE); Klaus STRASSER, Eichstatt (DE)

(73) Assignee: AUDI AG, Ingolstadt (DE)

(21) Appl. No.: 18/716,329

(22) PCT Filed: Nov. 28, 2022
(86) PCT No.: PCT/EP2022/083468

§ 371 Date: Jun. 4, 2024

(30) Foreign Application Priority Data
Feb. 9, 2022 (DE) 10 2022 102 986.7

(51) Int. Cl. F25B 40/00; F25B 13/00; F25B 41/20

(52) U.S. Cl. CPC F25B 40/00; F25B 13/00; F25B 41/20

(57) ABSTRACT

A method for operating a refrigerant circuit for a motor vehicle, in which a control device selects function modules from a function library containing a plurality of function modules, which are assigned to respective components of the refrigerant circuit. The control device activates, for the operation of the refrigerant circuit, only those function modules contained in the function library which are assigned to components actually present in the refrigerant circuit to be operated and/or to actually provided interconnection options of the refrigerant circuit. In contrast, the control device deactivates those function modules contained in the function library which are assigned to components of the refrigerant circuit that are optionally usable but are not present in the refrigerant circuit to be operated and/or to interconnections of the refrigerant circuit that are not intended in the operation of the refrigerant circuit.

### FIELD

The invention relates to a method for operating a refrigerant circuit for a motor vehicle, in which a control device selects function modules from a function library containing a plurality of function modules, which are assigned to respective components of the refrigerant circuit. Furthermore, the invention also relates to a motor vehicle having such a refrigerant circuit and a control device.

### BACKGROUND

When designing and manufacturing refrigerant circuits for motor vehicles, software modules or function modules are usually developed depending on the structure of the respective refrigerant circuit, the interconnection options of such a refrigerant circuit, and the refrigerant used, which modules are assigned to the individual components and the selectable system configurations or interconnection options of the refrigerant circuit. The use of different refrigerants is accompanied by the development of functions differing from one another. Therefore, such a development involves a large time expenditure and high costs. This is because different functions are to be developed depending on the refrigerant used and depending on the existing components of the refrigerant circuit, their arrangement in the refrigerant circuit, and the selectable system configurations of the refrigerant circuit. This is disadvantageous in terms of functional variants, time expenditure, and costs.

US 2018/0135877 A1 describes a customer-specific adaptation of an air conditioning system using a database containing operating parameters and control parameters of system units.

EP 0 221 618 A1 describes a refrigeration system having application software for controlling the refrigeration system. When a new system is produced, programs from a program library are used which relate to individual components of the system and possible forms of a control thereof.

Another method for controlling the climate in a building area or plant area is described in DE 100 13 447 C1.

### SUMMARY

The object of the present invention is to specify a method of the type mentioned at the outset, which enables low-effort and flexible adaptation to changes in the refrigerant circuit, and to create a corresponding motor vehicle.

In the method according to the invention for operating a refrigerant circuit for a motor vehicle, a control device selects function modules from a function library containing a plurality of function modules. The function modules are assigned to the respective components of the refrigerant circuit. In order to operate the refrigerant circuit, the control device activates only those function modules contained in the function library which are assigned to components actually present in the refrigerant circuit to be operated and/or to actually intended interconnection options of the refrigerant circuit. In contrast, the control device deactivates those function modules contained in the function library which are assigned to components that are optionally usable but are not present in the refrigerant circuit to be operated and/or to connections of the refrigerant circuit that are not intended in the operation of the refrigerant circuit.

The interconnection options of the refrigerant circuit can also be referred to as system configurations and describe the respective operating modes of the refrigerant circuit, which can be implemented based on the actually present components of the refrigerant circuit. The connections of the refrigerant circuit that are not intended in the operation of the refrigerant circuit are therefore system configurations that cannot be represented or are not intended in the actual operation of the refrigerant circuit.

Unless a refrigerant circuit of maximum complexity is used, the control device will not activate function modules contained in the function library at all. Rather, only those function modules, in particular those designed as software modules, are activated and thus included in the control of the refrigerant circuit, which are assigned to the components actually present in the refrigerant circuit to be operated and which depict interconnection options or system configurations that can actually be represented or are intended. The function library can therefore contain a number of function modules that are not used or not activated, but are present or retained in the function library.

The process enables low-effort and flexible adaptation to changes of the refrigerant circuit. If at least one further component is to be added to the refrigerant circuit to be operated, or if an existing component is to be replaced by the further component, only the function module assigned to this further component and/or the function module assigned to at least one additional possible or intended connection or system configuration of the refrigerant circuit needs to be activated so that this function module can also be used in the operation of the refrigerant circuit.

Even if different refrigerants are used in the refrigerant circuit, the operation of the refrigerant circuit is based on the same functions. This is because only those function modules or software modules that are relevant when using the respective refrigerant need to be activated.

The individual function modules can be developed and designed in their basic form independently of the respective refrigerant. A material data reference or refrigerant reference can be incorporated into the overall design or the operation of the refrigerant circuit via separate refrigerant data sets.

The refrigerant circuit is therefore designed in such a way that, independently of the refrigerant used, it can use the same functional description contained in the function library. This is accompanied by reduced development effort. This is because only the generally applicable function library needs to be provided in the form of a central function, wherein only the function modules required for operating the refrigerant circuit and the interconnections or system configurations that can be depicted by it are activated. In contrast, functions or function modules that are not required are deactivated or hidden so that only the functionalities required for the respective structure of the refrigerant circuit are used.

The large, comprehensive function library contains all the functional scopes of even a very complex refrigerant circuit, for example in the form of a maximum expansion stage of the refrigerant circuit. Starting from this maximum expansion stage with the possible interconnections or system configurations, the functional development can be broken down very easily to the respective system or the respective refrigerant circuit according to the drop-down principle, since only the function modules that are actually to be used are to be activated with a then reduced number of interconnections or system configurations. Furthermore, the system architecture, i.e., the structure of the refrigerant circuit, can advantageously be easily scaled up or down depending on the motor vehicle to be equipped with the respective refrigerant circuit.

This is particularly associated with reduced effort, since software-based system development does not need to be carried out for each refrigerant circuit. Instead, the function modules that are already contained in the function library can simply be used. This results in a saving of time and money.

For use in a specific application, it is therefore first necessary to develop the function module that is independent of the refrigerant used and that in turn has to fulfill a specific task within a predefined interconnection of the refrigerant circuit or system configuration. The effort required for an application by specifying values that are to be processed by the respective function module is coupled to this uniform function module.

The function modules are retained in the function library in particular independently of the refrigerant actually used. However, the values processed by the function modules depend on the refrigerant actually used in the refrigerant circuit. An intervention may therefore only be carried out on the application side by providing the function modules with the values to be processed, which may depend in particular on the refrigerant used in the refrigerant circuit.

The function modules or software modules can in particular contain instructions for the operation of the respective component of the refrigerant circuit or for a respective interconnection or system configuration of the entire refrigerant circuit.

Advantageously, function modules for a coolant circuit that interacts with the refrigerant circuit in a heat-transferring manner during operation can remain unchanged.

The components actually present in the refrigerant circuit are preferably designed in terms of their strength so that they can withstand the requirements arising during operation of the refrigerant circuit, wherein in particular specific requirements for the refrigerant used in each case are taken into consideration.

Preferably, during operation of the refrigerant circuit, the function modules activated by the control device process values which take into consideration properties of a refrigerant actually present in the refrigerant circuit. This makes it very easy to apply specific variables relating to the respective refrigerant. This is accompanied by a comparatively low application effort. In particular, a material data library assigned to the respective refrigerant can be used.

Preferably, the control device for operating the refrigerant circuit activates a function module which is assigned to a refrigerant reservoir arranged on a low-pressure side of the refrigerant circuit. Such a positioning of the refrigerant reservoir, in which in particular a separation of liquid refrigerant and gaseous refrigerant and preferably a storage or removal of refrigerant takes place, is advantageous in particular when a transcritical refrigerant is used in the refrigerant circuit, i.e., a refrigerant which can be present in the refrigerant circuit temporarily in subcritical and temporarily in supercritical states.

In contrast, when using a refrigerant that operates subcritically or only has subcritical conditions during operation of the refrigerant circuit, the arrangement of the refrigerant reservoir on a high-pressure side of the refrigerant circuit is more advantageous. In an embodiment in which a subcooling section is integrated into a condenser of the refrigerant circuit, the refrigerant reservoir can be integrated into the condenser between a condensation section of the condenser and the subcooling section for a particularly favorable provision of this function. This makes providing a refrigerant reservoir on the low-pressure side superfluous.

Furthermore, such a refrigerant circuit can have an expansion element by means of which an operating state having superheated refrigerant can be set downstream of an evaporator of the refrigerant circuit. If the subcritical refrigerant is only present in the gas phase on the low-pressure side of the refrigerant circuit, no separation of liquid refrigerant can be carried out in the refrigerant reservoir.

In the present case, however, the function module which is assigned to the refrigerant reservoir arranged on the low-pressure side of the refrigerant circuit is preferably activated. This means that even when using transcritical refrigerant in the refrigerant reservoir, liquid refrigerant can be separated. In this case, an operating strategy with a high-pressure control can be carried out for the at least one expansion element installed upstream of at least one evaporator of the refrigerant circuit, which is modified in relation to an operating strategy in which the refrigerant reservoir is arranged on the high-pressure side.

However, if the process for a transcritical refrigerant is subcritical due to the applied system load, the at least one expansion element installed upstream of the at least one evaporator of the refrigerant circuit can map an operating strategy having a subcooling control downstream of the condenser.

The provision of the refrigerant reservoir on the low-pressure side of the refrigerant circuit thus enables the use of both the refrigerant having transcritical states and the refrigerant having only subcritical states during operation of the refrigerant circuit. This is advantageous in terms of a very extensive standardization of the structure of the refrigerant circuit largely independent of the refrigerant used.

The function library can contain a function module which is assigned to a refrigerant reservoir arranged on a high-pressure side of the refrigerant circuit. Preferably, however, such a function module remains or is deactivated in this case.

Preferably, the control device for operating the refrigerant circuit activates a function module which is assigned to an internal heat exchanger of the refrigerant circuit. Such an internal heat exchanger ensures an increase in the temperature of the refrigerant supplied to a compressor of the refrigerant circuit and an additional cooling of the refrigerant supplied to at least one evaporator of the refrigerant circuit. Such an internal heat exchanger is particularly advantageous with regard to the efficiency of the refrigerant circuit when a transcritical refrigerant is used in the refrigerant circuit.

When using a refrigerant that only has subcritical conditions during operation of the refrigerant circuit, the use of the internal heat exchanger is more optional.

Since the refrigerant circuit in this case has the internal heat exchanger and the function module assigned to this heat exchanger is activated, both the transcritical refrigerant and the subcritical refrigerant can be advantageously used in the operation of the refrigerant circuit. In this case, the function module activated by the control device and assigned to the internal heat exchanger is advantageously used. The functional criteria according to which the refrigerant circuit operates are therefore the same, even if different refrigerants are used in this refrigerant circuit with regard to the states that occur.

Preferably, the function library provides respective function modules for operating the refrigerant circuit with a refrigerant having subcritical states, a refrigerant having supercritical states, and a refrigerant having transitions between a subcritical state and a supercritical state. These function modules then cover refrigerants that operate differently, so that such refrigerants can be used in the refrigerant circuit. Such a function library, which contains the function descriptions for the refrigerant placed in the respective states, can be used in a very versatile way by the control device.

Preferably, the control device only activates the at least one of these function modules which is associated with the actually occurring states of the refrigerant used in the refrigerant circuit. In contrast, those function modules which correspond to or are assigned to states of the refrigerant used which do not occur during operation of the refrigerant circuit can be deactivated by the control device. This makes the use of differently operating refrigerants in the refrigerant circuit particularly simple and inexpensive.

Preferably, an ambient temperature is taken into consideration when bringing the refrigerant used in the refrigerant circuit into the respective state. In this way, the function modules assigned to the different states of the refrigerant can very well provide a cooling capacity that depends on the ambient temperature.

For example, a refrigerant that can be brought into supercritical states can be used in accordance with the function module that is intended for operating the refrigerant circuit with the refrigerant that has subcritical states when comparatively low ambient temperatures exist.

If, on the other hand, higher ambient temperatures are present, the function module can be used which is intended for transitions between the subcritical state and the supercritical state of the refrigerant.

At even higher ambient temperatures, the function module can be used which is intended for operating the refrigerant circuit with the refrigerant having supercritical states. In this way, it is possible to respond very well to the cooling requirements of the refrigerant circuit present at the respective ambient temperatures.

Preferably, the function library contains respective function modules which specify an operating mode of respective evaporators. In this case, the control device only activates the at least one of these function modules which is assigned to at least one evaporator actually present in the refrigerant circuit. In this way, the operation of the refrigerant circuit can be adapted very easily if the refrigerant circuit has at least one further evaporator in addition to an evaporator. The function modules, which are assigned to the evaporators actually present in the refrigerant circuit, map in particular interconnections or system configurations which can be represented depending on the number of evaporators present in the refrigerant circuit.

For example, the function modules contained in the function library can specify, as a first interconnection or system configuration, the operation of a first evaporator which is arranged in a front area of a passenger compartment of the motor vehicle, in particular in an air conditioning unit of the motor vehicle, and can therefore be referred to as a front evaporator, which is usually supplied with air during operation.

Furthermore, the function library can contain a function module which specifies the operating mode of a second evaporator designed as a chiller or a further evaporator and thus describes a second or further interconnection or system configuration. Such a chiller absorbs heat from a coolant flow during operation. This coolant flow can be used, for example, to dissipate heat from an electrical energy storage device of the motor vehicle and/or from an electric motor of the motor vehicle.

The component of the refrigerant circuit in the form of a chiller is a heat exchanger with the function of an evaporator, which, during operation, absorbs heat from another fluid flowing through the heat exchanger in the form of the coolant and cools it down in the process. In this way, in particular, active cooling of a high-voltage component such as the electrical energy storage device and/or a drive machine such as the at least one electric motor of the motor vehicle can be achieved. If the chiller is present and the function module assigned to the chiller is activated, the system or the refrigerant circuit in the corresponding interconnection or system configuration can carry out battery cooling as programmed or in the correct manner.

It can be provided that in a single-chiller operation of the refrigerant circuit on the low-pressure side only one evaporator in the form of the chiller operates as a heat sink and in a dual-evaporator mode both the chiller and the front evaporator or interior evaporator operate as heat sinks or are active in the system or refrigerant circuit. In this way, a variable number of evaporators can be taken into consideration via a correspondingly pre-equipped function library.

Furthermore, the function library can contain a function module which specifies the operating mode of an evaporator which is intended for air conditioning a rear area of the passenger compartment and can therefore be referred to as a rear evaporator. If this additional evaporator is provided, a further interconnection or system configuration can be represented.

If the refrigerant circuit has only one evaporator, for example in the form of a front evaporator or interior evaporator, this can be used to map an interconnection or system configuration, for example in the form of interior air conditioning, by means of the front evaporator alone. If, for example, the rear evaporator is present as an additional evaporator in the refrigerant circuit, three interconnections or system configurations can be mapped or implemented, namely operation only with the front evaporator, operation only with the rear evaporator, and operation with the front evaporator and the rear evaporator together.

If a chiller is added to the two evaporators mentioned, all three evaporators or heat exchangers can be operated together in a further system configuration, and in still further interconnections or system configurations each of the three evaporators or heat exchangers can be operated alone, and in still further interconnections or system configurations two of the three heat exchangers can be operated together in pairs.

For each of the above-mentioned interconnections or system configurations, an independent function module can be stored in the function library, which can be activated or deactivated depending on the evaporators actually present.

If the refrigerant circuit to be operated only has the front evaporator, only the function module assigned to the front evaporator is activated by the control device. In contrast, the function modules assigned to the chiller and the rear evaporator are deactivated. Nevertheless, the operation of the refrigerant circuit can be adapted very easily if the refrigerant circuit installed in the motor vehicle has at least one of the further evaporators, for example the chiller and/or the rear evaporator. This is advantageous in terms of low-effort and flexible adaptation to changes in the refrigerant circuit.

Preferably, the function library contains a first function module which is assigned to a heat exchanger which uses an air flow as a heat source in a heat pump operation of the refrigerant circuit, and a second function module which is assigned to a further heat exchanger which uses a coolant flow as a heat source in a heat pump operation of the refrigerant circuit. In this case, the control device only activates at least one of these function modules, which is assigned to at least one heat exchanger actually present in the refrigerant circuit and using the heat source in heat pump operation. In this way, heat pump operation can be implemented with very little effort using the refrigerant circuit, provided that the routing of the refrigerant through the respective heat exchanger allows the corresponding heat pump operation of the refrigerant circuit when the heat source is used. This contributes to a high degree of flexibility in the operation of the refrigerant circuit.

Due to the different interconnections or system configurations mentioned as examples, which are made possible by a different number of heat exchangers in the refrigerant circuit, a respective function module can be assigned to a higher-level element, for example in the form of a function module group. In such a function module group of the function library, subfunctions can be assigned to the respective function modules on the basis of the different interconnection options. For example, in a function module group relating to the operation of evaporators, the individual function modules can describe different interconnections in which, for example, one of the evaporators is operated alone or multiple evaporators are operated together. This applies analogously to other heat exchangers in the refrigerant circuit. Providing such function module groups simplifies the handling of the function library. In this way, a maximum number of interconnection options and refrigerant flow options can be mapped and described.

The motor vehicle according to the invention has a refrigerant circuit and a control device, wherein the control device is designed to select function modules from a function library containing a plurality of function modules, which are assigned to respective components of the refrigerant circuit. The control device is further designed to activate, for the operation of the refrigerant circuit, only those function modules contained in the function library which are assigned to components actually present in the refrigerant circuit to be operated and/or to actually provided interconnection options of the refrigerant circuit, and to deactivate those function modules contained in the function library which are assigned to components of the refrigerant circuit that are optionally usable but are not present in the refrigerant circuit to be operated and/or to interconnections of the refrigerant circuit that are not intended in the operation of the refrigerant circuit.

Accordingly, the control device is designed to carry out the method according to the invention, and low-effort and flexible adaptation to changes in the refrigerant circuit is possible in the motor vehicle.

The control device for the motor vehicle is also part of the invention. The control device can have a data processing device or a processor device which is configured to carry out an embodiment of the method according to the invention. For this purpose, the processor device can have at least one microprocessor and/or at least one microcontroller and/or at least one FPGA (Field Programmable Gate Array) and/or at least one DSP (Digital Signal Processor). Furthermore, the processor device can have program code which is configured to carry out the embodiment of the method according to the invention when it is executed by the processor device. The program code can be stored in a data memory of the processor device. Advantageously, it can be provided that the data storage device can be externally provided with basic data or can be populated and/or modified with basic data and can thus be overwritten or rewritten.

In this way, updates of function modules can in particular be transferred and/or, in the event of any modifications or conversions to the system or refrigerant circuit, new or previously deactivated function modules can be activated or set to an active status. This means that the control device, which can be designed as a control unit, for example, can react flexibly to new boundary conditions or be adapted to them.

The advantages and preferred embodiments described for the method according to the invention also apply to the motor vehicle according to the invention and vice versa.

The invention accordingly also includes developments of the motor vehicle according to the invention, which have features as already described in the context of the developments of the method according to the invention. For this reason, the corresponding developments of the motor vehicle according to the invention are not described again here.

The motor vehicle according to the invention is preferably designed as an automobile, in particular as a passenger car or truck, or as a passenger bus.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 schematically shows a refrigerant circuit of a motor vehicle, which enables the use of the same function modules independently of the refrigerant present in the refrigerant circuit;

FIG. 2 shows a schematic representation of the motor vehicle having the very schematically shown refrigerant circuit according to FIG. 1;

FIG. 3 shows process curves illustrating possible operating modes of the refrigerant circuit in a subcritical process, a transcritical process, and a supercritical process; and

FIG. 4 shows a curve or characteristic line which can be used for high-pressure control of the refrigerant circuit.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

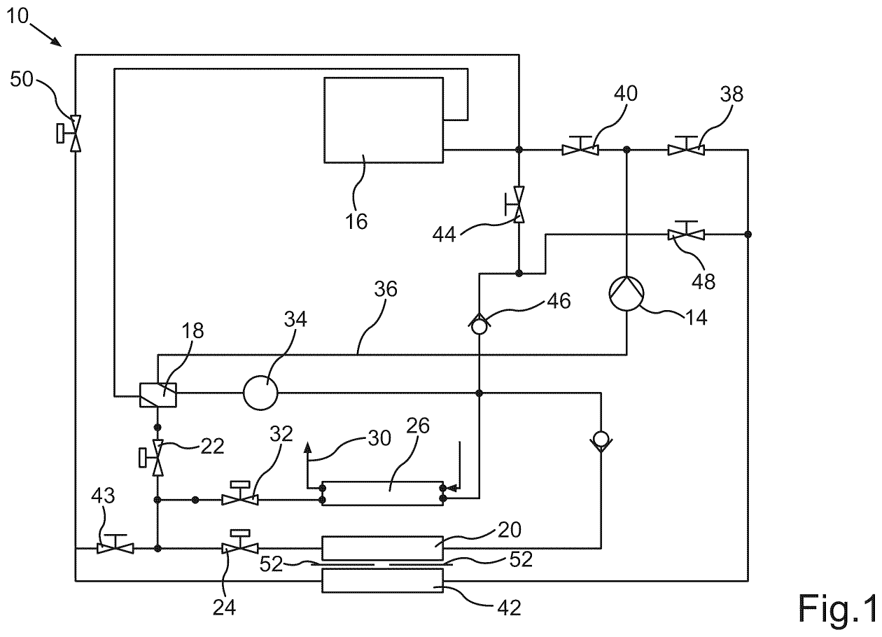

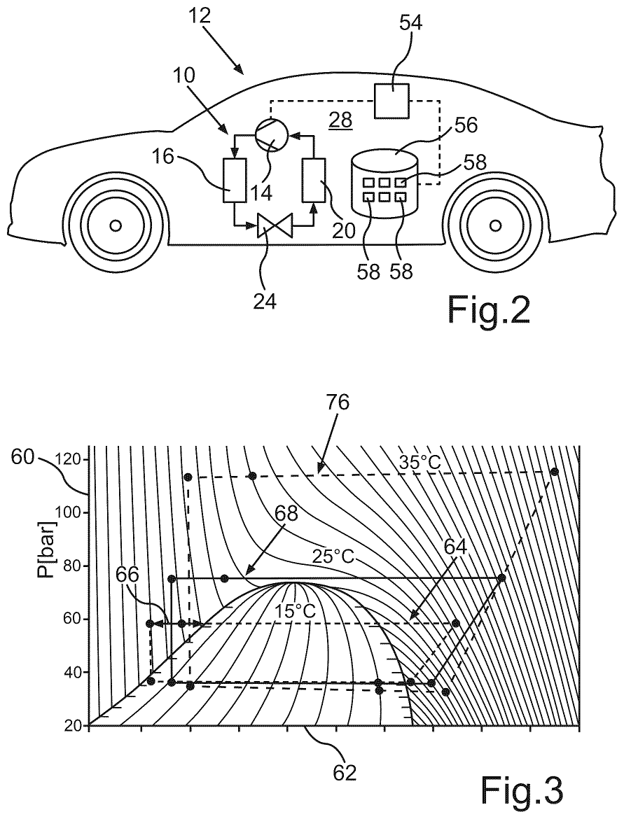

FIG. 1 shows schematically and by way of example a refrigerant circuit 10 as it can be used in a motor vehicle 12 shown in FIG. 2. The refrigerant circuit 10 comprises a compressor 14, which can be designed, for example, as an electrically driven refrigerant compressor. In an air conditioning system operation of the refrigerant circuit 10, the compressor 14 feeds the compressed refrigerant to a condenser or gas cooler 16, in which a cooling, in particular a condensation and subcooling of the compressed refrigerant when designed as a condenser, can take place. In the air conditioning operation of the refrigerant circuit 10, the refrigerant is first passed through an internal heat exchanger 18 and then fed to an evaporator 20, which can be arranged in particular in an air conditioning unit (not shown) of the motor vehicle 12.

In this air conditioning operation of the refrigerant circuit 10, a shut-off device 22 is open. The shut-off device 22, which can be designed in particular as an expansion element which can be shut off and through which flow can occur bidirectionally, is arranged according to FIG. 1 between the internal heat exchanger 18 and an expansion element 24 which is connected upstream of the evaporator 20 and is used to expand the refrigerant. By means of the evaporator 20, an air flow can be cooled and/or dehumidified, which can be introduced into a passenger compartment 28 of the motor vehicle 12 (see FIG. 2).

According to FIG. 1, a further evaporator can be connected in parallel to the evaporator 20, which in this application is designed as a so-called chiller 26. While the air flow or the air which is to be introduced into the passenger compartment 28 of the motor vehicle 12 can be cooled and/or dehumidified by means of the evaporator 20 in the air conditioning operation of the refrigerant circuit 10, the evaporator designed as the chiller 26 is used to absorb heat from a coolant flow 30, which is indicated schematically in FIG. 1. An expansion element 32 is also connected upstream of the chiller 26, by means of which the refrigerant coming from a high-pressure side section of the internal heat exchanger 18 can be expanded.

The refrigerant coming from the evaporator 20 and/or the chiller 26 is fed to a refrigerant reservoir 34, which in this case is arranged on a low-pressure side of the refrigerant circuit 10. Accordingly, a refrigerant line 36 of the refrigerant circuit 10 leading from the refrigerant reservoir 34 to the compressor 14 is connected to a low-pressure side of the compressor 14. According to FIG. 1, a low-pressure side section of the internal heat exchanger 18 is integrated into this refrigerant line 36.

Other possible evaporators, such as a rear evaporator for conditioning an air supply flow for a rear area or rear compartment of the motor vehicle 12, are not shown in FIG. 1 for reasons of clarity and a description thereof is not necessary for an understanding of the ideas or facts to be explained below.

According to FIG. 1, the refrigerant circuit 10 can also be operated in a heat pump operation, in which, for example, an air flow flowing over or through the gas cooler 16 or the coolant flow 30 can be used as a heat source.

In the heat pump operation, by opening a first shut-off valve 38 and closing a further shut-off valve 40, it can be ensured that the refrigerant delivered by the compressor 14 is fed to a heating register 42, which can be arranged, for example, in the air conditioning unit of the motor vehicle 12, in particular downstream of the evaporator 20.

In the heat pump operation of the refrigerant circuit 10, a further shut-off valve 43 is opened and, for example, the shut-off device 22, which is preferably designed as an expansion element, is used to expand the refrigerant, which is then initially fed to the gas cooler 16. In the gas cooler 16, heat is absorbed from the air flow which flows over or through the gas cooler 16. From the gas cooler 16, the refrigerant then returns to the low-pressure side of the compressor 14 when the shut-off valve 44 is open, in this case via a check valve 46 and the refrigerant reservoir 34.

Furthermore, in the heat pump operation of the refrigerant circuit 10, the refrigerant coming from the heating register 42 can be expanded by means of the expansion element 32 connected upstream of the chiller 26 when the shut-off valve 43 is open and the shut-off device 22 is closed and can then be fed to the chiller 26. In this case, the coolant stream 30 is used as a heat source. In this heat pump operation, the refrigerant coming from the chiller 26 is also fed to the low-pressure side of the compressor 14 via the refrigerant reservoir 34 and the internal heat exchanger 18.

Furthermore, in a post-heating operation of the refrigerant circuit 10, the refrigerant compressed by the compressor 14 and initially fed to the heating register 42 can be fed to the gas cooler 16 by at least partially opening a further shut-off device 50 and then from there to the evaporator 20 via the expansion element 24 connected upstream of the evaporator 20 with the shut-off valve 44 closed and the shut-off device 22 open. By partially opening the further shut-off device 50, which is used as an expansion device in the post-heating operation, it can be ensured that the refrigerant flowing through the gas cooler 16 has an average pressure, i.e., a pressure which is lower than the high pressure present on the outlet side of the compressor 14, but higher than the low pressure present on the inlet side of the compressor 14. If the shut-off device 50 is opened further, a two-pressure situation comprising only the low pressure and the high pressure is established from a certain cross section through which flow can occur.

Further operating modes of the refrigerant circuit 10 and respective switching positions of valves of the refrigerant circuit 10, such as the shut-off device 50 and a further shut-off valve 48, as well as of air flaps 52 arranged, for example, in the air conditioning unit, can be found, for example, in DE 10 2018 213 232 A1.

A control device 54 of the motor vehicle 12 used to control and/or regulate the refrigerant circuit 10, which is not shown separately in FIG. 1 for reasons of clarity, is shown in FIG. 2. According to FIG. 2, the control device 54 can access a function library 56, which can be provided in particular in the motor vehicle 12. The function library 56 associated with the motor vehicle 12 in the present case contains a plurality of function modules 58, of which only some are provided with a reference number in FIG. 2.

In an alternative approach, it can be provided that complete software creation in a maximum configuration is carried out outside the motor vehicle 12 and only a final data packet is transferred to the vehicle-internal control device 54. As part of the software creation, it is possible to access a function library 56 that exists externally to the vehicle, for example one stored on a data server. Within the framework of a specific vehicle project, the function modules 58 provided for the specific vehicle project can be used to map a respective system configuration from a maximum possible configuration. These function modules 58 can be integrated into a function software creation. During the production process or assembly process of the motor vehicle 12 having the corresponding refrigerant circuit 10, the software package can be transferred on the one hand and corresponding connections of the refrigerant circuit 10 can be stored on the other hand via a data input of the control unit or the control device 54.

The required bits to activate or deactivate certain functionalities and/or system configurations can be set or left open in this case. Accordingly, by simply changing a switch position in which a respective bit is either set or not set, the maximum functionality can be reduced to the functionality actually given or actually present in the refrigerant circuit 10. Such a reduction in functionality only has to be performed, of course, if the actual structure of the refrigerant circuit 10 or the intended operating modes of the refrigerant circuit 10 require it.

For reasons of simplicity, only a few components of the refrigerant circuit 10 shown in FIG. 1 are shown in FIG. 2, namely the compressor 14, the gas cooler 16, the expansion element 24, and the evaporator 20. In fact, however, the refrigerant circuit 10 shown in FIG. 2 and arranged in the motor vehicle 12 preferably has the components explained with reference to FIG. 1.

The function modules 58 contained in the function library 56 are assigned to respective components of the refrigerant circuit 10. Additionally or alternatively, the function modules 58 contained in the function library 56 are assigned to interconnection options or system configurations of the refrigerant circuit 10, which can be set or mapped in the refrigerant circuit 10. For example, one of the function modules 58 can be assigned to the compressor 14, while another of the function modules 58 is assigned to the gas cooler 16. This applies analogously to other components of the refrigerant circuit 10, such as the evaporator 20, the chiller 26, the expansion elements 24, 32 connected upstream of these evaporators, the heating register 42, the internal heat exchanger 18, the refrigerant reservoir 34, and the like. Preferably, one of the function modules 58 provided in the function library 56 is also assigned to each of the respective shut-off devices 22, 50 and shut-off valves 38, 40, 43, 44, 48.

Furthermore, it can be provided that a respective one of the function modules 58 is assigned to a respective system configuration or interconnection variant of the refrigerant circuit 10. For example, a function module 58 can be assigned to a conditioning of the supply air solely by means of the evaporator 20, which is introduced into the interior or passenger compartment 28 of the motor vehicle 12. This function module 58 is thus assigned to the components intended to represent such a function of the refrigerant circuit 10 and their operating mode.

A further function module 58 can be assigned to an interconnection of the coolant circuit 10, in which cooling of a battery or such an electrical energy storage device (not shown) of the motor vehicle 12 takes place by dissipating heat from the coolant flow 30 solely by means of the chiller 26.

A third function module 58 can be assigned to an interconnection of the refrigerant circuit 10, in which a dual operation takes place in which both the evaporator 20 and the chiller 26 are subjected to refrigerant.

In the present case, the control device 54 activates for the operation of the refrigerant circuit 10 only those function modules 58 contained in the function library 56 which are assigned to components actually present in the refrigerant circuit 10 to be operated. In contrast, the control device 54 deactivates function modules 58 contained in the function library 56 which are assigned to components not present in the refrigerant circuit 10, wherein these components can be provided in a different configuration of the refrigerant circuit 10 than that shown by way of example in FIG. 1.

The activation and deactivation of the function modules 58 can be carried out in particular during the manufacturing of the motor vehicle 12. This is because it is then known which components are installed in the refrigerant circuit 10 and which system configurations or interconnections are to be implemented. Accordingly, a respective bit can be activated or deactivated, for example based on a structure code or function code which is assigned to the control device 54. Accordingly, the control device 54 can set the bit to 1 when the respective function module 58 is activated and can set the bit to 0 when the respective function module is deactivated.

Function modules 58 which are not required for the operation of the respective refrigerant circuit 10 and which are contained in the function library 56 of the motor vehicle 12 but are not required for the operation of the refrigerant circuit 10 are accordingly hidden or deactivated by the control device 54. If, for example, the chiller 26 is not present, neither the function module 58 assigned to the chiller 26 nor the function module 58 assigned to the expansion element 32 need to be activated by the control device 54. Therefore, all system configurations or interconnections that affect operation of the chiller 26, which is not even present in this case, can be deactivated and in particular the bit assigned to the corresponding function module 58 can be set to “0”.

However, if the chiller 26 and the expansion element 32 connected upstream of the chiller 26 are provided in accordance with the expansion stage of the refrigerant circuit 10 actually present in the motor vehicle 12, the function modules 58 which are assigned to these components of the refrigerant circuit 10 are activated by the control device 54. In this case, all system configurations or interconnections that affect an operation of the chiller 26 present in the refrigerant circuit 10 can be activated and in particular the bit assigned to the respective function module 58 can be set to “1”.

In this procedure, it is particularly advantageous that, on the one hand, a synthetic refrigerant such as R1234yf can be used in the refrigerant circuit 10 or a natural refrigerant such as R744, i.e., carbon dioxide. independently of which of these refrigerants is used in the

refrigerant circuit 10, the structure of the refrigerant circuit 10 shown in FIG. 1 can be used. The refrigeration system or the refrigerant circuit 10 is therefore designed in such a way that, independently of the refrigerant used, the same functional description is used, which is stored in the function library 56 in the form of the function modules 58 or software modules.

During the application, the material data associated with the respective refrigerant are preferably used to specify values which are then processed by the function modules 58 or software modules during operation of the refrigerant circuit 10. The function modules 58 can thus be kept in the function library 56 independently of the refrigerant actually used, but the values processed by the respective function module 58 are preferably dependent on the refrigerant used.

In order to provide a structure of the refrigerant circuit 10 in which both a transcritical refrigerant such as R744 and a subcritical refrigerant such as R1234yf can be used, the topology of the refrigerant circuit 10 shown in FIG. 1 can be used, for example.

If the refrigerant R744 is used, the refrigerant reservoir 34 is preferably arranged on the low-pressure side of the refrigerant circuit 10, and it is expedient for thermodynamic reasons or with regard to performance and efficiency to also provide the internal heat exchanger 18.

In contrast, if, for example, R1234yf is to be used as a subcritical refrigerant in the refrigerant circuit 10, the refrigerant reservoir 34 is preferably arranged on the high-pressure side of the refrigerant circuit 10 and the internal heat exchanger 18 is optional.

According to the structure of the refrigerant circuit 10 shown in FIG. 1, a standardization of basic concepts of the refrigeration system or the refrigerant circuit 10 can be seen in that the refrigerant reservoir 34 is arranged on the low-pressure side. In addition, the internal heat exchanger 18 is provided for both systems or refrigerant circuits 10.

If, for example, R744 is to be used as a transcritical refrigerant in the refrigerant circuit 10, it is advantageous to provide respective function modules 58 for operating the refrigerant circuit 10, which correspond to supercritical states of the refrigerant and which correspond to subcritical states of the refrigerant. Furthermore, a function module 58 is to be provided for operating the refrigerant circuit 10 using a refrigerant having transitions between the subcritical state and the supercritical state.

In contrast, for example, if R1234yf is used as a subcritical refrigerant, only the function module 58 for operating the refrigerant circuit 10 using the refrigerant having the subcritical states is to be provided.

In the present case, the function library 56 thus contains the function modules 58 for operating the refrigerant circuit 10 using, for example, the refrigerant R744 and for operating the refrigerant circuit 10 using, for example, the refrigerant R1234yf. If the refrigerant R1234yf is actually used in the refrigerant circuit 10, the function modules 58 for operating the refrigerant circuit 10 having a refrigerant having supercritical states and for refrigerants having transitions between the subcritical state and the supercritical state are hidden or deactivated.

Furthermore, a substance data library can be converted from R744 to R1234yf. The refrigerant circuit 10 then operates on this data basis, based on which values are processed that take into consideration the properties of the refrigerant R1234yf. With the optimized operation of the refrigerant circuit 10 enabled here, only this application effort is required.

Furthermore, in addition to the function modules 58 assigned to the evaporator 20 and the chiller 26, the function library 56 can contain, for example, a further function module 58 which is assigned to a further evaporator (not shown) of the refrigerant circuit 10, which can be designed as a rear evaporator.

However, in the embodiment of the refrigerant circuit 10 shown as an example in FIG. 1, such a rear evaporator, which is used to condition an air flow to be introduced in particular into the rear area of the passenger compartment 28, is not present. Therefore, the function module 58 assigned to the rear evaporator and contained in the function library 56 is deactivated by the control device 54. In this case, this applies analogously to data regarding possible system configurations or interconnections of the refrigerant circuit 10, which are related to operation of the rear evaporator (not shown).

And if the refrigerant circuit 10, for example, only has the evaporator 20, which can also be referred to as a front evaporator due to its arrangement in the air conditioning unit of the motor vehicle 12, the function modules 58 assigned to the chiller 26 and the rear evaporator as well as the interconnections or system configurations of the function library 56 associated with the chiller 26 and the rear evaporator can be deactivated.

With reference to FIG. 1, in addition to the air conditioning operation of the refrigerant circuit 10, heat pump functions of the refrigerant circuit 10 have been described, wherein, for example, the air flow fed to the gas cooler 16 or the coolant flow 30 fed to the chiller 26 can be used as heat sources. If the refrigerant circuit 10 is now operated in such a way that only the coolant flow 30 is to be used as a heat source, those function modules 58 can be hidden or deactivated by the control device 54 which are assigned to the operation of the gas cooler 16 as a heat exchanger for heat pump operation and the valves and/or shut-off elements or the like to be switched during such operation. Accordingly, in heat pump operation, the refrigerant circuit 10 operates only as a water heat pump and not as an air heat pump.

When designing the refrigerant circuit 10, it also plays a role which refrigerants could be used in the refrigerant circuit 10. If, for example, R1234yf is used as the refrigerant, the arrangement of the refrigerant reservoir 34 not on the low-pressure side of the refrigerant circuit 10 as shown in FIG. 1, but on the high-pressure side of the refrigerant circuit 10 is advantageous.

However, if only the software module or function module 58 for such a refrigerant reservoir 34 arranged on the high-pressure side of the refrigerant circuit 10 were present in the function library 56, a changeover to the refrigerant R744, for example, would require the provision of a further function module 58, which is assigned to the refrigerant reservoir 34 shown in FIG. 1 and arranged on the low-pressure side of the refrigerant circuit 10. This is avoided in the present case.

On one hand, independently of the type of refrigerant used, the refrigerant reservoir 34 is arranged on the low-pressure side of the refrigerant circuit 10. On the other hand, the function library 56 can contain both the function module 58 or software module for the refrigerant reservoir 34 arranged on the low-pressure side of the refrigerant circuit 10 and a further function module 58 or software module for a refrigerant reservoir 34 arranged on the high-pressure side of the refrigerant circuit 10. However, due to the actual arrangement of the refrigerant reservoir 34 on the low-pressure side of the refrigerant circuit 10, this further or last-mentioned function module 58 does not need to be activated. Furthermore, this function module 58 does not need to be developed separately at all if only the refrigerant reservoir 34 arranged on the low-pressure side of the refrigerant circuit 10 is provided throughout all topologies of the refrigerant circuit 10.

Providing the refrigerant reservoir 34 on the low-pressure side of the refrigerant circuit 10 is thermodynamically advantageous, particularly when using the refrigerant R744.

If R1234yf is used as a refrigerant or R744 is used as a refrigerant in the refrigerant circuit 10, the function modules 58 present in the function library 56 can be used, in particular if the refrigerant circuit 10 is not intended to have a heat pump function. And independently of whether R1234yf or R744 is used as the refrigerant, the refrigerant circuit 10 is suitable for use in a country or region having comparatively high ambient temperatures.

By providing the refrigerant reservoir 34 or refrigerant collector on the low-pressure side of the refrigerant circuit 10 and the internal heat exchanger 18, a changeover from the refrigerant R1234yf to the refrigerant R744 can be carried out without any problems, for example, without the need to add further function modules 58 to the function library 56. Therefore, the refrigerant circuit 10 shown in FIG. 1 is advantageous in terms of performance and efficiency as well as cost.

In addition, both the refrigerant R1234yf and the refrigerant R744 can be used in the refrigerant circuit 10 without having to make significant changes with regard to the installation space required by the components of the refrigerant circuit 10 in the motor vehicle 12. Furthermore, all components of a coolant circuit (not shown) of the motor vehicle 12 assigned to the coolant flow 30 can be retained unchanged.

In a graph shown in FIG. 3, the pressure is plotted on an ordinate 60 and the enthalpy on an abscissa 62. A first, self-contained process curve 64 illustrates an operation of the refrigerant circuit 10 using a subcritical refrigerant.

For example, at ambient temperatures of less than approximately 25 degrees Celsius, a subcritical process corresponding to the process curve 64 can be used in the refrigerant circuit 10, as is provided, for example, in a control of a refrigerant circuit or refrigerant circuit in which the refrigerant R1234yf is used. In particular, a subcooling control can be carried out in a subcooling section 66 of the process curve 64, in which the liquid refrigerant present on the outlet side of the gas cooler 16, which is then operated as a condenser, is further subcooled.

Another self-contained process curve 68 in FIG. 3 illustrates a transcritical process in the area of the critical point, in which both subcritical states of the refrigerant and supercritical states of the refrigerant occur. Here, the temperature of the refrigerant at an outlet side of the gas cooler 16 can be used as a control variable. On the basis of this temperature, a compromise operation of the refrigerant circuit 10 can be implemented, in which a control according to an optimal high pressure or after subcooling can be provided in each case at the outlet of the gas cooler 16. A control strategy accompanying this process curve 68 can be used, for example, when ambient temperatures, but in particular refrigerant temperatures at the outlet of the gas cooler 16, are, for example, more than approximately 25 degrees Celsius but less than approximately 35 degrees Celsius.

Although the temperature of the refrigerant at the outlet of the gas cooler 16 is in reality above the ambient temperature, it can nevertheless be used for the control strategy as essentially corresponding to the ambient temperature. In order to simplify or optimize the control strategy, however, it is possible in particular to use a temperature signal and/or a pressure signal, which can be detected at the outlet of the gas cooler 16.

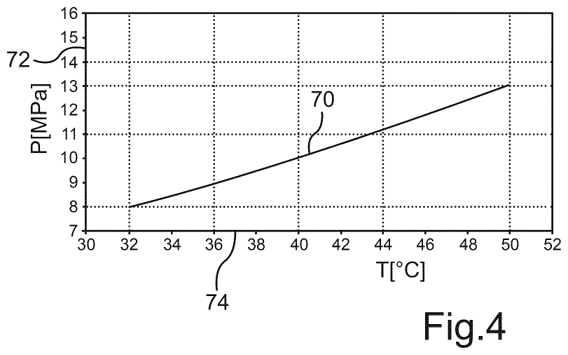

In a graph shown in FIG. 4, a continuously rising curve 70 illustrates a relationship between the temperature of the refrigerant on the outlet side or exit side of the gas cooler 16 and the pressure of the refrigerant on the high-pressure side of the compressor 14. In the graph shown in FIG. 4, the pressure is plotted on an ordinate 72 and the temperature on an abscissa 74.

In particular, in the transcritical process, which is illustrated by the process curve 68 in FIG. 3, a high-pressure control of the compressor 14 can be carried out, wherein the high pressure of the refrigerant caused by the compressor 14 can be adjusted depending on the temperature of the refrigerant at the outlet of the gas cooler 16. For such a high-pressure control, the control device 54 can use the curve 70 shown in FIG. 4.

In FIG. 3, a third self-contained process curve 76 is shown, which illustrates a possible operation of the refrigerant circuit 10 when a refrigerant having supercritical states is used. This process curve 76 can be used by the control device 54, for example, when ambient temperatures, but in particular refrigerant temperatures at the outlet of the gas cooler 16, are, for example, more than 35 degrees Celsius.

If the refrigerant R744 is used in the refrigerant circuit 10, the function module 58 for subcritical operation of the refrigerant circuit 10 can be used for the subcritical operating range. This function module 58 can be used in an analogous manner if the refrigerant R1234yf is used in the refrigerant circuit 10. However, if the refrigerant R744 is used and the algorithm or function module 58 corresponding to subcritical operation is used, a data set is preferably used which is assigned to the refrigerant R744.

And for the transcritical range, if the refrigerant R744 is used in the refrigerant circuit 10, the control device 54 preferably activates the corresponding software module or function module 58 which is assigned to the operation of the refrigerant circuit 10 in this transcritical range.

In the subcritical range, both when using the refrigerant R1234yf and when using the refrigerant R744, a subcooling control carried out by the control device 54 is advantageous, while in the supercritical range a high-pressure control carried out by the control device 54 is advantageous, for example in accordance with the relationship illustrated in FIG. 4. Transitions between these controls can be defined, in particular, depending on the pressure. Alternatively, a compromise operation between subcooling control or pressure control can be provided.

In particular, depending on the ambient temperature, the control device 54 can specify which of the function modules 58 assigned to the respective states of the refrigerant is to be used in controlling the respective components of the refrigerant circuit 10 and is activated accordingly.

During operation of the refrigerant circuit 10, an interaction of sensors (not shown here) and possibly further control devices with the control device 54 can be provided, which are known to the person skilled in the art and play a rather subordinate role in explaining the present concept. Furthermore, for reasons of clarity, a representation and explanation of such sensors and/or other control units has been omitted.

1-10. (canceled)

11. A method for operating a refrigerant circuit for a motor vehicle, in which a control device selects function modules from a function library containing a plurality of function modules, which are assigned to respective components of the refrigerant circuit, wherein the control device activates, for the operation of the refrigerant circuit, only those function modules contained in the function library which are assigned to components actually present in the refrigerant circuit to be operated and/or to actually provided interconnection options of the refrigerant circuit, and deactivates those function modules contained in the function library which are assigned to components of the refrigerant circuit that are optionally usable but are not present in the refrigerant circuit to be operated and/or to interconnections of the refrigerant circuit that are not intended in the operation of the refrigerant circuit.

12. The method according to claim 11, wherein during operation of the refrigerant circuit, the function modules activated by the control device process values which take into consideration properties of a refrigerant actually present in the refrigerant circuit.

13. The method as claimed in claim 11, wherein the control device for operating the refrigerant circuit activates a function module which is assigned to a refrigerant reservoir arranged on a low-pressure side of the refrigerant circuit.

14. The method as claimed in claim 11, wherein the control device for operating the refrigerant circuit activates a function module which is assigned to an internal heat exchanger of the refrigerant circuit.

15. The method as claimed in claim 11, wherein the function library provides respective function modules for operating the refrigerant circuit with a refrigerant having subcritical states, a refrigerant having supercritical states, and a refrigerant having transitions between a subcritical state and a supercritical state.

16. The method as claimed in claim 15, wherein the control device only activates the at least one of these function modules which is associated with the actually occurring states of the refrigerant used in the refrigerant circuit.

17. The method as claimed in claim 15, wherein an ambient temperature is taken into consideration when bringing the refrigerant used in the refrigerant circuit into the respective state.

18. The method as claimed in claim 11, wherein the function library contains respective function modules which specify an operating mode of respective evaporators, wherein the control device only activates the at least one of these function modules which is assigned to at least one evaporator actually present in the refrigerant circuit.

19. The method as claimed in claim 11, wherein the function library contains a first function module which is assigned to a heat exchanger which uses an air flow as a heat source in a heat pump operation of the refrigerant circuit, and a second function module which is assigned to a further heat exchanger which uses a coolant flow as a heat source in a heat pump operation of the refrigerant circuit, wherein the control device only activates at least one of these function modules which is assigned to at least one heat exchanger actually present in the refrigerant circuit and using the heat source in the heat pump operation.

20. A motor vehicle having a refrigerant circuit and having a control device which is designed to select function modules from a function library containing a plurality of function modules, which are assigned to respective components of the refrigerant circuit, wherein the control device is designed to activate, for the operation of the refrigerant circuit, only those function modules contained in the function library which are assigned to components actually present in the refrigerant circuit to be operated and/or to actually provided interconnection options of the refrigerant circuit, and to deactivate those function modules contained in the function library which are assigned to components of the refrigerant circuit that are optionally usable but are not present in the refrigerant circuit to be operated and/or to interconnections of the refrigerant circuit that are not intended in the operation of the refrigerant circuit.

21. The method as claimed in claim 2, wherein the control device for operating the refrigerant circuit activates a function module which is assigned to a refrigerant reservoir arranged on a low-pressure side of the refrigerant circuit.

22. The method as claimed in claim 12, wherein the control device for operating the refrigerant circuit activates a function module which is assigned to an internal heat exchanger of the refrigerant circuit.

23. The method as claimed in claim 13, wherein the control device for operating the refrigerant circuit activates a function module which is assigned to an internal heat exchanger of the refrigerant circuit.

24. The method as claimed in claim 12, wherein the function library provides respective function modules for operating the refrigerant circuit with a refrigerant having subcritical states, a refrigerant having supercritical states, and a refrigerant having transitions between a subcritical state and a supercritical state.

25. The method as claimed in claim 13, wherein the function library provides respective function modules for operating the refrigerant circuit with a refrigerant having subcritical states, a refrigerant having supercritical states, and a refrigerant having transitions between a subcritical state and a supercritical state.

26. The method as claimed in claim 14, wherein the function library provides respective function modules for operating the refrigerant circuit with a refrigerant having subcritical states, a refrigerant having supercritical states, and a refrigerant having transitions between a subcritical state and a supercritical state.

27. The method as claimed in claim 16, wherein an ambient temperature is taken into consideration when bringing the refrigerant used in the refrigerant circuit into the respective state.

28. The method as claimed in claim 12, wherein the function library contains respective function modules which specify an operating mode of respective evaporators, wherein the control device only activates the at least one of these function modules which is assigned to at least one evaporator actually present in the refrigerant circuit.

29. The method as claimed in claim 13, wherein the function library contains respective function modules which specify an operating mode of respective evaporators, wherein the control device only activates the at least one of these function modules which is assigned to at least one evaporator actually present in the refrigerant circuit.

30. The method as claimed in claim 14, wherein the function library contains respective function modules which specify an operating mode of respective evaporators, wherein the control device only activates the at least one of these function modules which is assigned to at least one evaporator actually present in the refrigerant circuit.
